(19) United States
(12) Patent Application Publication
(10) Pub. No.: US 2003/0160904 A1
(43) Pub. Date: Aug. 28, 2003

(54) Tuner that can convert television signal to signal suitable for QAM demodulation

(76) Inventor: Syuuji Matsuura, Ikoma-shi (JP)

Correspondence Address: BIRCH STEWART KOLASCH & BIRCH, PO BOX 747, FALLS CHURCH, VA, 22040-0747, US

(21) Appl. No.: 10/336,539

(22) Filed: Jan. 6, 2003

(30) Foreign Application Priority Data
Feb. 22, 2002 (JP) 2002-046602

(51) Int. Cl. H04N 5/50

(52) U.S. Cl. 348/731

(57) ABSTRACT

A PIN attenuator circuit within a digital STB tuner is connected to an output-side of a high-pass filter, and a PIN attenuator circuit is connected to an input-side of high-frequency amplification input tuning circuits. A buffer amplifier is connected between the PIN attenuator circuits. The PIN attenuator circuits and high-frequency AGC circuits are controlled in common.

### BACKGROUND OF THE INVENTION

1. Field of the Invention

The present invention relates to a tuner and, more specifically, to a tuner for a digital set top box (Set Top Box: abbreviated as STB hereafter) used for digital television broadcasting.

2. Description of the Background Art

Three kinds of digital television broadcasting (ground wave broadcasting, satellite broadcasting and cable television broadcasting) appeared from 1998 to 2000. A digital STB is an attachment for receiving such digital broadcasting with a television receiver. Digital STBs for ground wave broadcasting, satellite broadcasting and cable television broadcasting have similar configurations, and an input stream generally used in the digital STB is MPEG2 (Moving Picture Experts Group 2).

A front end circuit, software which depends on a CA (Conditional Access) system or a data broadcasting service system, a digital interface for connection to external equipment, and the like, however, are different depending on a specific kind of service or a provider.

A tuner for the digital STB is used for the front end of such a digital STB. The tuner converts a frequency of a received signal and provides the result as an intermediate frequency signal.

A reception of cable television broadcasting will now be described with an example of a conventional digital STB tuner.

For a cable television (abbreviated as CATV hereafter) signal, an up-link signal transmitted from a digital STB tuner to a CATV station is operated within 5 MHz-42 MHz, and a down-link signal transmitted from the CATV station to the digital STB tuner is operated within 54 MHz-860 MHz.

FIG. 4 is a block diagram of a configuration the conventional digital STB tuner.

Referring to FIG. 4, a digital STB tuner 100 includes a CATV signal input terminal 2 to which a CATV signal is input, a data input terminal 3 to which a data signal from a QPSK (Quadrature Phase Shift Keying) transmitter, which is not shown, is input, and an upstream circuit 4 provided between data input terminal 3 and CATV signal input terminal 2.

A data signal such as a QPSK data signal from the QPSK transmitter, which is not shown, is input to data input terminal 3. This data signal is transmitted as an up-link signal to the CATV station via upstream circuit 4. The data signal is received by a data receiver of the CATV station (system operator), and enters a central computer.

On the other hand, a down-link signal input to input terminal 2 is divided into a UHF band (also referred to as B3 band hereafter) receiving 470-860 MHz, a VHF-High band (also referred to as B2 band hereafter) receiving 170-470 MHz, and a VHF-Low band (also referred to as B1 band hereafter) receiving 54-170 MHz, and is processed by a reception circuit provided for each band. It is to be noted that, the range of each band described above is not specifically defined.

Digital STB tuner 100 further includes a high-pass filter 5 having an attenuation range of 5-46 MHz and a pass range equal to or higher than 54 MHz, and input switching circuits 6-8 for distributing each of B1-B3 bands signals passed through high-pass filter 5 to a circuit group corresponding to each band.

After passing through high-pass filter 5, the down-link signal is switched for each band by input switching circuits 6-8, and is fed to the circuit group corresponding to one of the above-described bands B1-B3.

Digital STB tuner 100 further includes high-frequency amplification input tuning circuits 9-11 respectively provided corresponding to B3-B1 bands, high-frequency AGC circuits 12-14 respectively provided corresponding to the UHF (B3) band, VHF-High (B2) band and VHF-Low (B1) band, AGC resistances 15-17, high-frequency amplification output tuning circuits 19-21 respectively provided corresponding to B3-B1 bands, a mixer circuit 22 and a local oscillator circuit 25 provided corresponding to B3 band, a mixer circuit 23 and a local oscillator circuit 26 provided corresponding to B2 band, a mixer circuit 24 and a local oscillator circuit 27 provided corresponding to B1 band, an intermediate frequency amplifier 28 to amplify outputs of mixer circuits 22-24 at an intermediate frequency range, and an output terminal 29 outputting an output signal of intermediate frequency amplifier 28.

The high-frequency amplification input tuning circuit, high-frequency AGC circuit, high-frequency amplification output tuning circuit, mixer circuit, and local oscillator circuit provided corresponding to each band have a function such that, corresponding to a received channel, a circuit group corresponding to a received band is set to an operative state while a circuit group corresponding to another band is set to an inoperative state.

When a channel of the UHF (B3) band is received, for example, high-frequency amplification input tuning circuit 9, high-frequency AGC circuit 12, high-frequency amplification output tuning circuit 19, mixer circuit 22, and local oscillator circuit 25 corresponding to the UHF (B3) band are set to operative states, while high-frequency amplification input tuning circuits 10, 11, high-frequency AGC circuits 13, 14, high-frequency amplification output tuning circuits 20, 21, mixer circuits 23, 24, and local oscillator circuits 26, 27 respectively corresponding to the VHS-High band and VHS-Low band are set to inoperative states to stop the operations.

The CATV signal input to CATV signal input terminal 2 passes through high-pass filter 5, and then enters input switching circuits 6-8 to be switched for each band. The output signal is input to corresponding one of high-frequency amplification input tuning circuits 9-11 to output a signal having a frequency corresponding to a desired channel. The output signal is amplified to a prescribed level by corresponding one of high-frequency AGC circuits 12-14 based on an AGC voltage input to AGC terminal 18, and the result is input to corresponding one of high-frequency amplification output tuning circuits 19-21 to output a signal having a frequency corresponding to a selected channel.

The signal having the frequency corresponding to the selected channel is converted to have an intermediate frequency (abbreviated as IF hereafter) by corresponding ones of mixer circuits 22-24 and local oscillator circuits 25-27, and the result is amplified by intermediate frequency amplifier 28.

An intermediate frequency signal (also referred to as IF signal hereafter) amplified by intermediate frequency amplifier 28 is output from output terminal 29.

As described above, conventional digital STB tuner 100 converts a received CATV signal to have a desired frequency corresponding to a received channel, and the signal having the desired frequency is converted and output from output terminal 29 as an IF signal.

The above-described conventional digital STB tuner generally operates in a single conversion system, in which a frequency of a received signal is converted and the result is then output as an IF signal. There are various problems as described below, however, to handle a QAM (Quadrature Amplitude Modulation) signal, which is a digital signal, with the conventional digital STB tuner and to send the IF signal output from output terminal 29 to a QAM demodulation circuit, which is not shown, for QAM demodulation.

(1) As the AGC voltage is supplied from one AGC terminal 18 to high-frequency AGC circuits 12-14 in the conventional digital STB tuner, transmission distortion such as an inter modulation or a cross modulation may easily occur.

The CATV signal easily causes transmission distortion because multifrequency signals are received by a community. The inter modulation of CSO (Composit System Order Beat) and CTB (Composit Triple Beat) in a gain attenuation amount of −10 dB to −20 dB is about −50 dBc, and the improvement thereof is especially needed.

(2) A control range of a gain control in an AGC function must be made wider to improve the transmission distortion. In the conventional digital STB tuner of the single conversion system, however, limitation of the gain attenuation amount is −35 dB to −40 dB.

(3) A dual gate-type MOSFET is commonly adopted to the high-frequency AGC circuit in the conventional digital STB tuner of the single conversion system. When the gain is controlled using such an element as the dual gate-type MOSFET, however, an input-output impedance inevitably changes. Consequently, in the high-frequency AGC circuit using the dual gate-type MOSFET element, a signal is incorrectly amplified and a selected channel varies.

(4) In the conventional digital STB tuner of the single conversion system, tuning properties of high-frequency amplification input tuning circuits 9-11 directly appear at CATV signal input terminal 2. Therefore, an input return loss cannot be compensated over a whole reception band.

(5) In the conventional digital STB tuner of the single conversion system, local leakage of local oscillator circuits 25-27 can easily appear at CATV signal input terminal 2. The local leakage of local oscillator circuits 25-27 is −20 dBV to −30 dBV, which does not satisfy a required reference value of −40 dBV of DOCSIS (Data Over Cable Service Interface Specifications).

In addition, harmonics are generated at high-frequency AGC circuits 12-14 with an effect of the up-link signal output from upstream circuit 4, which harmonics appear at CATV signal input terminal 2. A reference value of a spurious emission from upstream circuit 4 is −50 dBV, which value is very difficult to attain.

(6) In the conventional digital STB tuner of the single conversion system, the gain control is performed using an element such as the dual gate-type MOSFET, as described above. Thus, a transmission waveform changes. As a result, an image rejection ratio may be degraded to a value equal to or larger than −50 dBc.

### SUMMARY OF THE INVENTION

An object of the present invention is to provide a tuner for a digital STB, which tuner can output a signal suitable for a QAM demodulation.

A tuner according to the present invention includes a channel select circuit, a first gain control circuit and an amplifier. The channel select circuit receives a television signal and amplifies a signal having a desired frequency for conversion to an intermediate frequency signal. The first gain control circuit is provided previous to the channel select circuit, and adjusts an amplitude of the television signal. The amplifier is provided previous to the channel select circuit, and amplifies the television signal.

It is preferable that, the first gain control circuit receives the television signal, and the amplifier receives an output signal of the first gain control circuit.

It is more preferable that, the amplifier receives the television signal, and the first gain control circuit receives an output signal of the amplifier.

It is more preferable that, the first gain control circuit includes a first gain adjustment circuit and a second gain adjustment circuit. The first and second gain adjustment circuits adjust amplitudes of received signals. The amplifier is connected between the first and second gain adjustment circuits.

It is more preferable that, the tuner further includes a second gain control circuit adjusting an amplitude of a received signal, a stable voltage is supplied to the first and second gain adjustment circuits and the second gain control circuit, and the first and second gain adjustment circuits and the second gain control circuit are controlled in common.

It is more preferable that, the first gain control circuit is an attenuator circuit including a PIN diode.

With the above-described configuration, the tuner according to the present invention can have a wider gain control region using a plurality of gain adjustment circuits. In addition, the first gain control circuit provided previous to the amplifier attenuates a signal to prevent the amplifier from being saturated. Further, because the second gain control circuit stably attenuates an input signal to a prescribed level, a signal amplified in the second gain control circuit can be prevented from being saturated. As a result, transmission distortion is suppressed, and the transmission distortion and image rejection are improved. In addition, a spurious emission appearing at a CATV signal input terminal can be suppressed with the amplifier, and an input return loss can be improved. As a result, the tuner according to the present invention can convert a television signal to a signal suitable for a QAM demodulation.

In particular, when the configuration according to the present invention is applied to a tuner for receiving analog and digital channel signals of a digital STB, both of the analog and digital channels can be received.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a whole configuration of a tuner for a digital STB according to an embodiment of the present invention.

FIG. 2 is a circuit diagram showing a detailed configuration of a PIN attenuator circuit.

FIG. 3 is a circuit diagram showing a detailed configuration of a PIN attenuator circuit.

FIG. 4 is a block diagram of a configuration of a conventional tuner for a digital STB.

### DESCRIPTION OF THE PREFERRED EMBODIMENT

An embodiment of the present invention will now be described in detail with reference to the drawings. The same characters in the drawings indicate the same or corresponding portions, and the descriptions thereof will not be repeated.

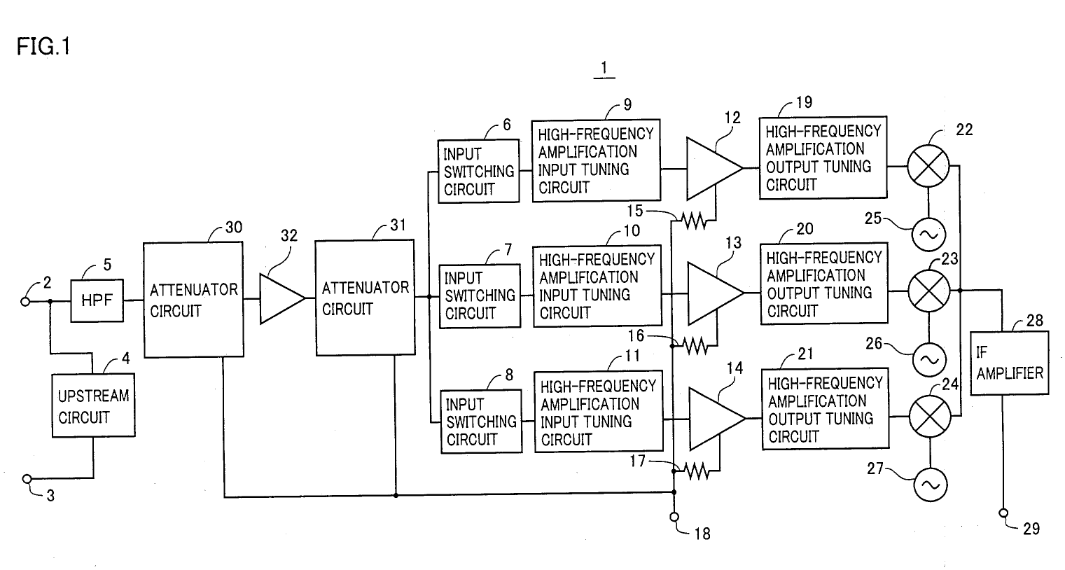

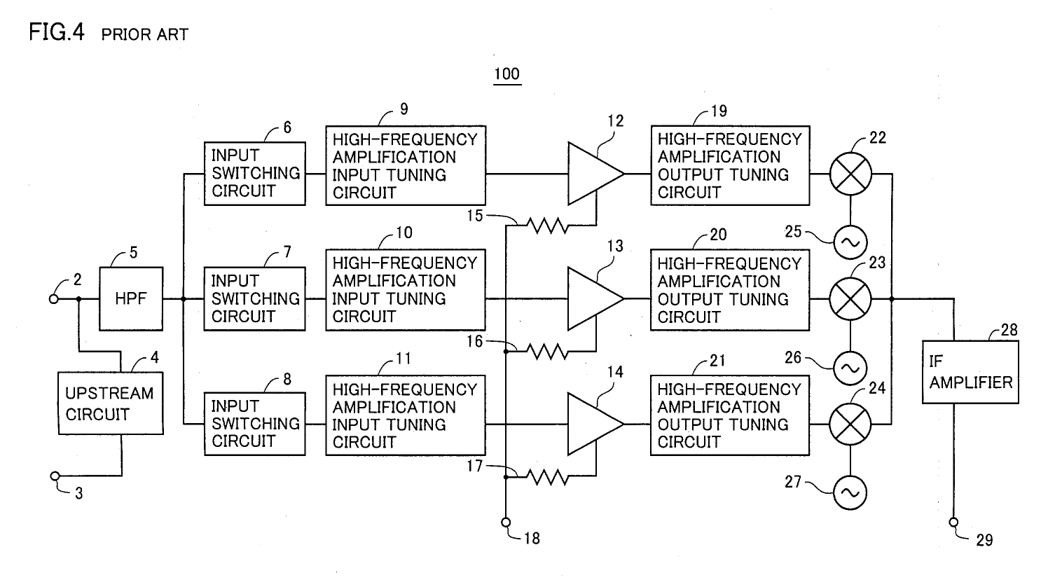

Referring to FIG. 1, as compared with conventional digital STB tuner 100 shown in FIG. 4, a digital STB tuner 1 according to an embodiment of the present invention further includes PIN attenuator circuits 30, 31 and a buffer amplifier 32.

PIN attenuator circuit 30 is connected to an output-side of high-pass filter 5. PIN attenuator circuit 31 is connected to an input-side of high-frequency amplification input tuning circuits 9-11. Buffer amplifier 32 is connected between PIN attenuator circuits 30 and 31.

Buffer amplifier 32 receives and amplifies a signal transmitted from PIN attenuator circuit 30, and outputs the result.

PIN attenuator circuits 30 and 31 attenuate an input signal to a desired level based on an AGC voltage input to AGC terminal 18.

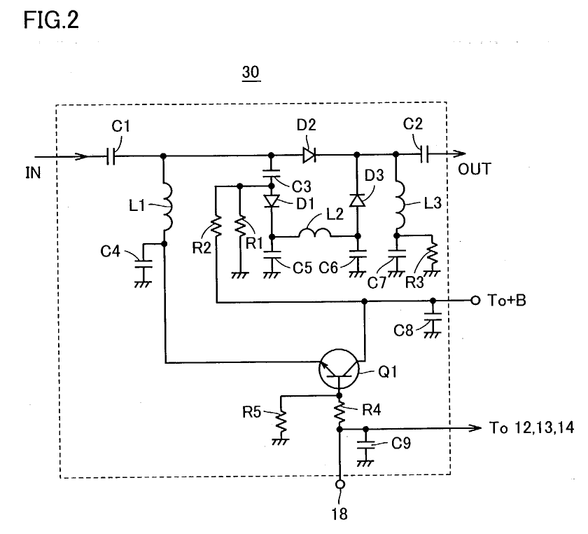

Referring to FIG. 2, PIN attenuator circuit 30 includes PIN diodes D1-D3, harmonic choke coils L1, L3, a high-frequency inductor L2, bypass capacitors C4-C9, bias resistances R1-R3, direct current stopping capacitors C1-C3, a transistor Q1, and resistances R4, R5 for setting a TOP (Take Over Point). Therefore, PIN attenuator circuit 30 is a π type PIN attenuator circuit having a function to decrease an effect of a load variation to a local oscillator circuit.

In PIN attenuator circuit 30, when an attenuation property is minimum, a resistance value of PIN diode D2 becomes equal to or lower than 1 ohm, for example, which is a minimum resistance value. Resistance values of PIN diodes D1 and D3 become several tens of ohms, which are maximum resistance values.

In PIN attenuator circuit 30, when the attenuation property is maximum, a resistance value of PIN diode D2 becomes a minimum value, and resistance values of PIN diodes D1 and D3 become minimum values.

Biases of PIN diodes D1-D3 are provided by resistances R1-R3. In addition, a bias current is supplied from a power supply +B via harmonic choke coils L1 and L3 by an operation of transistor Q1.

The AGC voltage is supplied from AGC terminal 18. The AGC voltage is input to transistor Q1 via TOP setting resistances R4 and R5. Transistor Q1 is driven by the AGC voltage converted by TOP setting resistances R4 and R5.

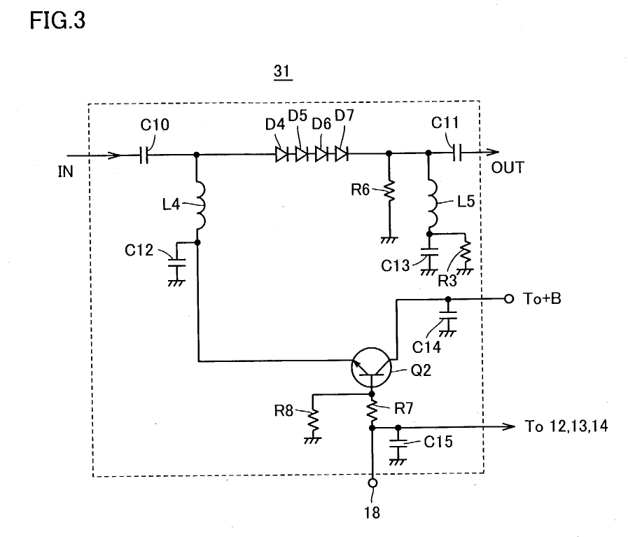

Referring to FIG. 3, PIN attenuator circuit 31 includes PIN diodes D4-D7, harmonic choke coils L4 and L5, direct current stopping capacitors C10 and C11, a bias resistance R6, bypass capacitors C12-C15, a transistor Q2, and resistances R7 and R8 for setting a TOP. Therefore, PIN attenuator circuit 31 is a serial-type PIN attenuator circuit.

PIN diodes D4-D7 are connected in series between direct current stopping capacitors C10 and C11. When an attenuation property is minimum, resistance values of PIN diodes D1-D4 become several ohms or lower, for example, which are minimum values. When the attenuation property is maximum, resistance values of PIN diodes D1-D4 become several tens of ohms, for example, which are maximum values. A bias current is supplied from power supply +B via harmonic choke coils L4, L5 and bias resistance R3 by an operation of transistor Q2 for an inverter. Transistor Q2 is driven by the AGC voltage converted to a desired level by TOP setting resistances R7 and R8.

It is to be noted that, in the present invention, PIN attenuator circuit 30 may have the configuration shown in FIG. 3, and PIN attenuator circuit 31 may have the configuration shown in FIG. 2.

As other portions of the digital STB tuner shown in FIG. 1 are the same as that shown in FIG. 4, detailed descriptions thereof will not be repeated.

Operations of digital STB tuner 1 in the embodiment of the present invention will now be described.

Similar to the operation of digital STB tuner 100, an up-link signal of the CATV signal is transmitted from data input terminal 3 to CATV signal input terminal 2 via upstream circuit 4 formed with a low-pass filter.

A down-link signal of the CATV signal is input from CATV signal input terminal 2 and passes through high-pass filter 5. Thereafter, the down-link signal is input to input switching circuits 6-8 via PIN attenuator circuit 30, buffer amplifier 32 and PIN attenuator circuit 31. Herein, PIN attenuator circuits 30 and 31 attenuate the CATV signal to a desired level based on the AGC voltage input to AGC terminal 18. The CATV signal is switched for each band by input switching circuits 6-8, and is supplied to a circuit group corresponding to one of the aforementioned bands B1-B3.

The high-frequency amplification input tuning circuit, high-frequency AGC circuit, high-frequency amplification output tuning circuit, mixer circuit, and local oscillator circuit provided corresponding to each band have a function such that, corresponding to a received channel, a circuit group corresponding to a received band is set to an operative state while a circuit group corresponding to another band is set to an inoperative state.

When a channel of B3 band is received, for example, high-frequency amplification input tuning circuit 9, high-frequency AGC circuit 12, high-frequency amplification output tuning circuit 19, mixer circuit 22, and local oscillator circuit 25 corresponding to B3 band are set to operative states, while high-frequency amplification input tuning circuits 10, 11, high-frequency AGC circuits 13, 14, high-frequency amplification output tuning circuits 20, 21, mixer circuits 23, 24, and local oscillator circuits 26, 27 respectively corresponding to B2 band and B1 band are set to inoperative states to stop the operations.

The CATV signal enters input switching circuits 6-8, and the band switching is performed. The output signal is then input to corresponding one of high-frequency amplification input tuning circuits 9-11, and a signal having a frequency corresponding to a desired channel is output. The output signal is amplified to a prescribed level by corresponding one of high-frequency AGC circuits 12-14 based on the AGC voltage input to AGC terminal 18, and the result is input to corresponding one of high-frequency amplification output tuning circuits 19-21 to output a signal having a frequency corresponding to a selected channel. The selected-channel signal is converted to have an intermediate frequency (abbreviated as IF hereafter) by corresponding ones of mixer circuits 22-24 and local oscillator circuits 25-27, and the result is amplified by intermediate frequency amplifier 28.

In the digital STB tuner having the configuration shown in FIG. 1, as PIN attenuator circuits 30, 31 attenuating an input signal to a desired level and high-frequency AGC circuits 12-14 are provided as an AGC control circuit, a signal input from the high-frequency AGC circuit is not saturated, and the high-frequency AGC control circuit can have a control range equal to or larger than −50 dB. As a result, distortion can be improved.

Further, in digital STB tuner 1 according to the present invention, each circuit is designed such that, PIN attenuator circuit 30 has a TOP (Take Over Point) of an input level of −3 dBmV, PIN attenuator circuit 31 has a TOP of an input level of 0 dBmV, for example, and high-frequency AGC circuits 12-14 have a TOP, for example, of an input level of +5 dBmV. As a result, operation start times of PIN attenuator circuits 30, 31 and the high-frequency AGC circuits differ. That is, PIN attenuator circuits 30, 31 and high-frequency AGC circuits 12-14 are designed to sequentially operate in this order. Therefore, an adverse effect of simultaneous operations of high-frequency AGC circuits 12-14 on the input signal can decrease. In addition, a control range of a signal at high-frequency AGC circuits 12-14 can be made narrower than that in the conventional digital STB tuner by previously attenuating the signal input to high-frequency AGC circuits 12-14 by PIN attenuator circuits 30 and 31. Thus, the transmission distortion generated by high-frequency AGC circuits 12-14 can be suppressed.

Herein, TOPs of PIN attenuator circuits 30, 31 and high-frequency AGC circuits 12-14 are set so as to optimize the transmission distortion and SNR (Signal to Noise) or CNR (Carrier to Noise), corresponding to a system design.

In addition, because the control range of a signal at high-frequency AGC circuits 12-14 can be made narrower, variations in a transmission property and an amplitude property, which are caused by adopting a dual gate-type MOS transistor in high-frequency AGC circuits 12-14, can be suppressed. Therefore, incorrect selection of the selected channel can be prevented. As an example, in 6 MHz BW (Band Width), SNR can be suppressed to −2 dB or smaller from a conventional value of −3 dB to −4 dB.

In addition, buffer amplifier 32 has a function of amplifying a signal in a forward direction, but attenuating a signal in a reverse direction. Thus, in the present invention, an input return loss can be improved, and the input return loss equal to or larger than 6 dB can be ensured over whole reception band of 54 MHz-860 MHz.

Further, harmonics generated at high-frequency AGC circuits 12-14 with an effect of the data signal output from upstream circuit 4 are attenuated by buffer amplifier 32. In addition, saturation of the signal amplified by buffer amplifier 32 can be suppressed by attenuating the signal by PIN attenuator circuit 30, and saturation of the signal amplified by each of high-frequency AGC circuits 12-14 can be suppressed by attenuating the signal by PIN attenuator circuit 31. As a result, a spurious emission at CATV signal input terminal 2 is improved. In addition, while the conventional local leakage is −20 dBmV to −30 dBmV, at least −40 dBmV, that is, the required reference value of DOCSIS can be satisfied with the configuration according to the present invention.

In addition, degradation of an image rejection can be prevented because a variation in a transmission waveform can be suppressed by narrowing the control range of a signal at high-frequency AGC circuits 12-14. As an example, while the image rejection in the conventional digital STB tuner is −50 dB to −40 dB or larger, the value can be improved to −55 dB or larger with the configuration according to the present invention.

It is to be noted that, though the CATV signal is representatively described as the received signal for the tuner of this embodiment, the signal is not limited to the CATV signal, and the present invention can correspond to various television signals such as a ground wave broadcasting signal or a satellite broadcasting signal.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A tuner, comprising:
a channel select circuit receiving a television signal and amplifying a signal having a desired frequency for conversion to an intermediate frequency signal;
a first gain control circuit provided previous to said channel select circuit for adjusting an amplitude of said television signal; and
an amplifier provided previous to said channel select circuit for amplifying said television signal.

2. The tuner according to claim 1, wherein
said first gain control circuit receives said television signal, and said amplifier receives an output signal of said first gain control circuit.

3. The tuner according to claim 1, wherein
said amplifier receives said television signal, and said first gain control circuit receives an output signal of said amplifier.

4. The tuner according to claim 1, wherein
said first gain control circuit is an attenuator circuit including a PIN diode.

5. The tuner according to claim 1, further comprising
a second gain control circuit provided subsequent to said channel select circuit for adjusting an amplitude of an output signal of said channel select circuit.

6. The tuner according to claim 5, wherein
said first gain control circuit is an attenuator circuit including a PIN diode.

7. The tuner according to claim 1, wherein
said first gain control circuit includes
a first and a second gain adjustment circuits each adjusting an amplitude of a received signal,
said amplifier is connected between said first gain adjustment circuit and said second gain adjustment circuit and receives an output signal of said first gain adjustment circuit, and said second gain adjustment circuit receives an output signal of said amplifier.

8. The tuner according to claim 7, further comprising
a second gain control circuit adjusting an amplitude of a received signal, wherein
a stable voltage is supplied to said first and second gain adjustment circuits and said second gain control circuit, and said first and second gain adjustment circuits and said second gain control circuit are controlled in common.

9. The tuner according to claim 8, wherein
said first gain control circuit is an attenuator circuit including a PIN diode.
